(19) United States
(12) Patent Application Publication
(10) Pub. No.: US 2012/0211093 A1
(43) Pub. Date: Aug. 23, 2012

(54) PUMP ASSEMBLIES WITH FREEZE-PREVENTIVE HEATING

(75) Inventor: David J. Grimes, Beaverton, OR (US)

(73) Assignee: Micropump, Inc.

(21) Appl. No.: 13/402,047

(22) Filed: Feb. 22, 2012

Related U.S. Application Data
(60) Provisional application No. 61/463,784, filed on Feb. 22, 2011.

(51) Int. Cl. F16K 49/00; F01C 21/06; F04B 53/00

(52) U.S. Cl. 137/334; 417/313; 418/83

(57) ABSTRACT

Pumps are disclosed that include a pump housing and at least one movable pumping element situated in the housing. The pumping element(s) are magnetically driven by magnetically coupling an external magnet driver (e.g., a stator) to a driven magnet located in the housing. A control circuit selectively operates the stator and a heat-producing element, so as to energize the heat-producing element especially in a potential freezing condition when the pump is not being otherwise operated. Thus, the fluid in the pump is prevented from freezing, and freeze-related pump damage is avoided. The heat-producing element can be the stator itself energized differently from when the stator is used for driving the pump.

### CROSS REFERENCE TO RELATED APPLICATION

This application claims priority to and the benefit of U.S. Provisional Patent Application No. 61/463,784, filed on Feb. 22, 2011, which is incorporated herein by reference in its entirety.

### FIELD

This disclosure pertains to, inter alia, gear pumps and other pumps configured to operate in a substantially primed condition to urge flow of a fluid. The subject pumps and pump-heads include various types having one or more rotary members, such as meshed gears, or at least one movable pumping member that operates continuously in a cyclic manner. More specifically, the disclosure pertains to pump assemblies and pump-heads that are capable of producing a phase-transition of the fluid in the pump-head from solid to liquid (and/or of preventing a phase-transition of the fluid in the pump-head from liquid to solid) to protect the pump-head from possible damage that otherwise could be caused by a freezing event, or the like.

### BACKGROUND

Several types of pumps are especially useful for pumping liquids and other fluids with minimal back-flow and that are amenable to miniaturization. An example is a gear pump, another example is a piston pump, and a third example is a variation of a gear pump in which the rotary pumping members have lobes that interdigitate with each other. Gear pumps and related pumps have experienced substantial acceptance in industry due to their comparatively small size, quiet operation, reliability, and cleanliness of operation with respect to the fluid being pumped. Gear pumps and related pumps also are advantageous for pumping fluids while keeping the fluids isolated from the external environment. This latter benefit has been further enhanced with the advent of magnetically coupled pump-drive mechanisms that have eliminated leak-prone hydraulic seals that otherwise would be required around pump-drive shafts, and thus enabled the development and use of sealed pump housings.

Gear pumps have been adapted for use in many applications, including applications requiring extremely accurate delivery of a fluid to a point of use. Consequently, these pumps are widely used in medical devices and scientific instrumentation. Developments in many other areas of technology have generated new venues for accurate pumps and related fluid-delivery systems. Such applications include, for example, delivery of liquids in any of various automotive applications. These automotive applications are demanding from technical, reliability, and environmental viewpoints. Technical demands include spatial constraints, ease of assembly and repair, and efficacy. Reliability demands include requirements for high durability, vibration-resistance, leak-resistance, maintenance of hydraulic prime, and long service life. Environmental demands include internal and external corrosion resistance, and ability to operate over a wide temperature range.

A typical automotive temperature range includes temperatures substantially below the freezing temperature of water and other dilute aqueous liquids that are exemplary pump fluids. These temperatures can be experienced, for example, whenever a motor vehicle is left out in freezing winter climate. Pumps with sealed housings tend to maintain hydraulic prime when not operating. With such pumps, a phase change of the fluid in the housing from liquid to solid renders the pump (designed for pumping liquid) incapable of normal operation and may permanently damage the pump. Hence, it is desirable that the pump assembly include a capacity for adding heat to the pump-head and/or the pump fluid (or frozen solid thereof) in the pump housing to prevent freezing of the pump fluid or to melt the solid thereof, respectively, when and as necessary.

In view of the above, the simplest solution that might be proposed is simply to add anti-freeze to the fluid or to constitute the fluid with sufficient solute to depress its freezing point. Unfortunately, changing the fluid in these ways changes its composition and possibly other important properties of the fluid, which may render the fluid ineffective for its intended purpose. Hence, there is a need for pump assemblies that can effectively add heat to the fluid in the pump housing for thawing and/or freeze-prevention purposes when required, including times in which the pump is in a primed condition but not actually pumping the fluid.

### SUMMARY

The needs articulated above are met by, inter alia, pump assemblies, pump-heads, and methods as disclosed herein. The subject pumps and pump-heads operate in a substantially primed condition. The pump can be, by way of example, a gear pump or a piston pump, but it will be understood that these specific types of pumps are not intended to be limiting. Various other specific types of pumps can readily be configured as described herein.

As used herein, a “pump medium” is the material actually pumped by the pump. Pumpability of a medium requires that the medium be a fluid, typically but not necessarily a liquid (in the liquid phase or at least include a liquid carrier). The liquid can be a suspension of or include solid particles. However, under extreme conditions the medium can be or include a solid phase. An example condition is exposure to a temperature sufficiently low for a requisite amount of time. Solids are generally not pumpable. A technical problem addressed by this invention is preventing the medium contained in the pump housing, whether the pump is running or not, from becoming unpumpable. Another technical problem addressed by this invention is prevention of a freezing condition, for the medium in the pump housing, that can damage the pump.

An embodiment of a gear-pump “pump-head” comprises a pump housing of which the pump cavity is a gear cavity. The pump housing also includes at least one inlet hydraulically coupled to the gear cavity, at least one outlet hydraulically coupled to the gear cavity, and at least one driving gear and one driven gear situated in and enmeshed with each other in the gear cavity. The gears are termed (and are examples of) “pump elements.” The pump housing of the gear pump-head can further include a rotor housing (also called a “magnet cup” or “cup-housing”). The rotor housing defines a rotor cavity that is in hydraulic communication with the gear cavity. The rotor housing normally contains the medium as well as a rotatable driven magnet that is coupled to the driving gear. Rotation of the magnet about its axis in the rotor housing causes corresponding contra-rotations of the driving gear and the driven gear in the gear cavity.

A “pump assembly” is a pump-head that includes means for causing pumping motion of at least one pump element. In many embodiments of a pump assembly a stator is placed in coaxial surrounding relationship to, but outside, the rotor housing. The stator is electronically energized, using a “driver” circuit, in a controlled manner to produce, even though the stator is stationary, a rotating electromagnetic field. The electromagnetic field penetrates through the rotor housing to engage the driven magnet and cause corresponding rotation of the driven magnet about its axis. Since the permanent magnetic field produced by the magnet is coupled to the rotating electromagnetic field produced by the stator, the rotating electromagnetic field “drives” (causes rotation of) the magnet.

The various embodiments of pump assemblies include heat-producing means that controllably, as required, heats the pump-head, the housing, and/or the medium in the housing to reverse or prevent freezing of the medium in the housing. “Controllably” means that the subject feature is turned on or off and/or operated in an active manner using dedicated component(s), rather than passively as a by-product of pump operation. The heat-producing means desirably is “integrated,” which means that components providing or constituting the subject feature are deliberately incorporated into the pump assembly.

The foregoing and additional features and advantages of the subject methods will be more readily apparent from the following detailed description, which proceeds with reference to the accompanying drawings.

### BRIEF DESCRIPTION OF THE DRAWINGS

FIG. 1 is a partially schematic cutaway view of a pump-head for a gear-pump, showing key features thereof.

FIG. 2 is a diagram of eddy-current induction utilized by many embodiments for heating the pump by delivering electrical current to the stator.

FIG. 3 is a schematic diagram of an exemplary driver circuit configured not only to drive operation of a pump but also to sense the ambient temperature of the pump (particularly at times when the pump is primed by but not pumping fluid) and to deliver electric current to the pump's stator to generate heat by induction if heating is indicated.

FIGS. 4A and 4B are respective orthogonal views of an embodiment of a stator used for both driving the magnet inside the pump housing and supplying heat to the pump.

FIG. 5 is a perspective sectional view of an embodiment of a pump assembly, showing the driven magnet and stator axially surrounding a magnet cup containing the driven magnet.

FIG. 6 is a schematic diagram of an exemplary embodiment of a hydraulic circuit including a pump assembly as described herein.

### DETAILED DESCRIPTION

The exemplary embodiments described herein are not intended to be limiting in any way. This disclosure is directed toward all novel and non-obvious features and aspects of the disclosed embodiments, alone and in various combinations and sub-combinations with one another. The disclosure is not limited to any specific aspect or feature or combinations thereof, nor does the disclosure require that any one or more specific advantages be present or problems be solved.

As used herein, the singular forms “a,” “an,” and “the” include the plural forms unless the context clearly dictates otherwise. Additionally, the term “includes” means “comprises.” Further, the term “coupled” encompasses mechanical as well as other practical ways of coupling or linking items together, and does not exclude the presence of intermediate elements between the coupled items.

In the disclosure, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

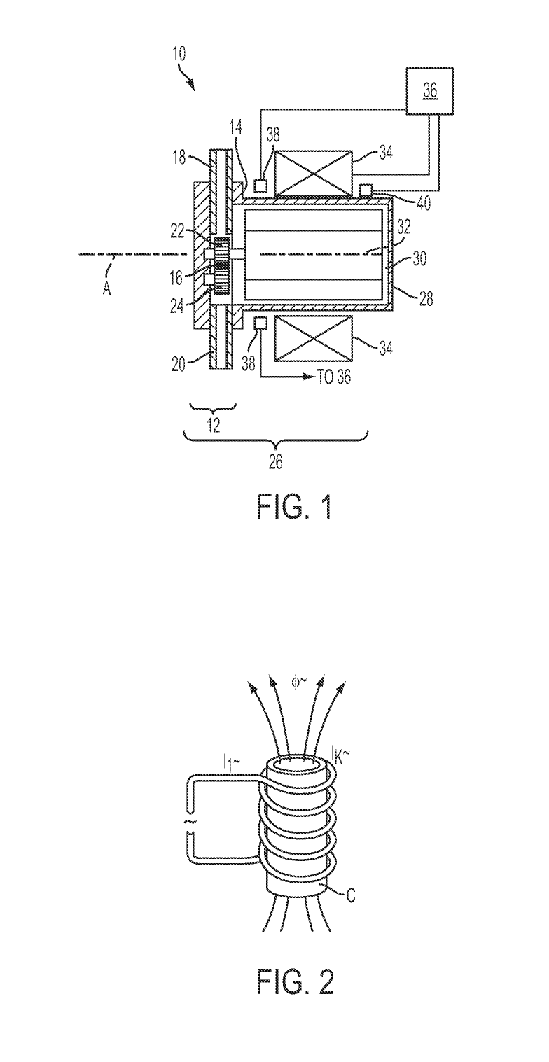

Certain aspects of the invention pertain to pump assemblies that operate in a substantially primed condition. An exemplary embodiment of a pump 10 is shown in FIG. 1. The pump 10 includes a “pump-head” 12 that comprises a housing 14. The housing 14 defines a pump-cavity 16. The pump-head 12 also comprises an inlet 18 for fluid to enter the pump-cavity 16 and an outlet 20 for pumped fluid to exit the pump-cavity. The pump-cavity 16 accommodates at least one pump-element that is driven to move inside the pump-cavity in a manner urging flow of the fluid via the inlet 18 into the pump-cavity and from the pump-cavity via the outlet 20. Example pump-elements include, but are not limited to, pistons and sets of interdigitated gears (shown in FIG. 1 as items 22 and 24). A “pump assembly” 26 is a pump-head 12 that includes a “mover” which comprises means for causing rotation or other actuation of at least one pump element in the pump cavity. The pump assembly 26 can be, for example, a gear pump or a piston pump, but it will be understood that these specific pumps are not intended to be limiting, since various other specific types of pumps can readily be driven as described herein.

The pump-cavity 16 of many gear-pumps contains a pair of intermeshed gears, including a driving gear 22 and a driven gear 24 that contra-rotate when driven to do so. Thus, in gear-pumps the pump-cavity 16 is termed a “gear-cavity.” The housings 14 of many gear-pumps also include a rotor housing 28 (also called a “magnet cup” or “cup-housing”). The rotor housing 28 defines a rotor-cavity 30 (also called a “magnet cavity”) that is in hydraulic communication with the gear-cavity. The rotor cavity 30 contains the medium and a rotatable permanent “driven magnet” 32 (or analogous “magnetically responsive means”) that is coupled to the driving gear 22. In this depicted embodiment, the magnet 30 is the “rotor” contained in the rotor housing 28. The driven magnet 32 is rotatable about its axis A in the rotor-cavity 30, which causes corresponding rotation of the driving gear 22 (at an equal angular velocity) and of the driven gear 24 in the gear-cavity 16. Since the driven magnet 32 is cylindrical, the rotor-cavity 30 is also cylindrical, with an inside diameter and length slightly greater than the outside diameter and length, respectively, of the driven magnet. The rotor-cavity 30 is in hydraulic communication with the pump cavity 16. Consequently, since the housing 14 is sealed, the housing retains some of the liquid being pumped by the pump (thereby maintaining, at least to some degree, hydraulic prime of the pump) even when the pump is not being operated.

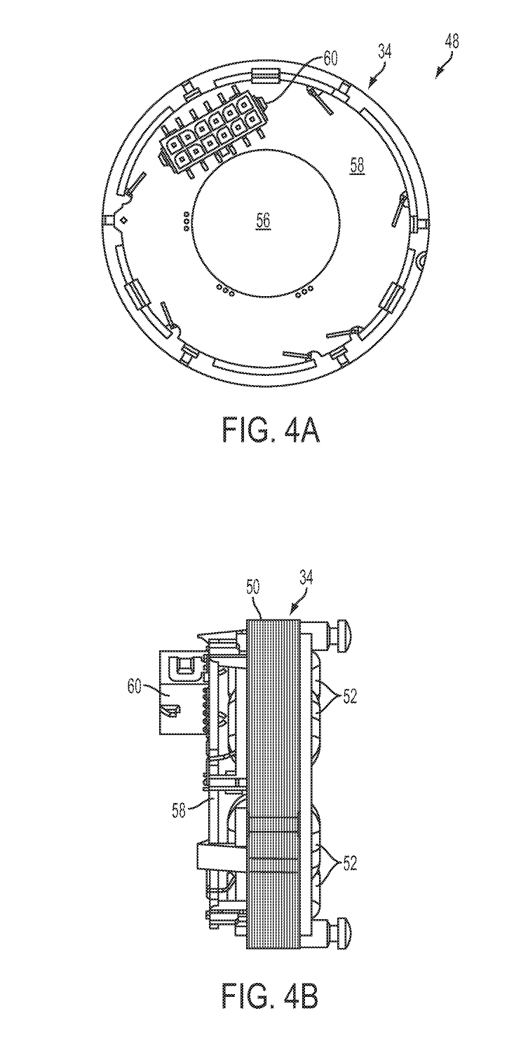

In many embodiments of a pump assembly the mover comprises a stator 34 placed in coaxial surrounding relationship to, but outside, the rotor housing 28. The stator 34 comprises a core 50 and electrical windings 52 (FIGS. 4A-4B). The windings 52 are electronically energized, using a “driver” circuit 36 (FIG. 1), in a controlled rotational manner to produce, even though the stator 34 is stationary, a rotating electromagnetic field. As a result of the stator 34 surrounding the rotor-cavity 30, the electromagnetic field produced by the stator 34 penetrates through the rotor housing 28 and engages the permanent magnetic field produced by the driven magnet 32. As the magnetic field produced by the stator 34 rotates, the magnet 32 correspondingly rotates. Thus, the stator 34 “drives” (i.e., causes rotation of) the driven magnet 32. To such end, the windings of the stator 34 are connected to the driver circuit 36. By locating the stator 34 outside the housing 14 and the magnet 32 inside the housing, the housing can be “sealed.” A sealed housing advantageously requires no dynamic seal for operating the pump, and can maintain hydraulic prime even when the pump is not operating. In a gear pump, driving of the magnet 32 directly causes direct driving of the driving gear 22 to rotate about its axis, which produces corresponding opposite-direction rotation of the driven gear 24 about its axis. I.e., the gears 22, 24 “contra-rotate” in the pump-cavity 16. Contra-rotation of the gears 22, 24 produces an elevated pressure condition that urges flow of the fluid through the pump 14 housing from the inlet 18 to the outlet 20. Typically, the pressure condition is one in which the pressure in the outlet 20 is greater than the pressure in the inlet 18 as a result of the pump elements being driven.

Whereas the embodiments described above are gear pumps, other embodiments are configured as piston pumps, or other type of pump comprising a moving pump element that can be situated in a pump-cavity and coupled to a driven magnet.

In some embodiments (not shown), the driven magnet inside the housing is magnetically coupled not to a stator 34 but rather to a rotatable second magnet (called a “driving magnet”) located outside the pump housing coaxially with the driven magnet. The driving magnet is mounted, for example, on the armature of a motor such that rotation of the armature about its axis correspondingly rotates the driven magnet about its axis. The axially rotating magnetic field produced by rotation of the driving magnet causes corresponding rotation of the driven magnet about its axis. Use of a stator 34 as shown in FIG. 1 is preferred because it has fewer parts and generally is more compact and more rugged than an otherwise similarly sized pump assembly of which the mover is a driving magnet.

The various embodiments of pump assemblies also include a heat-producing means that controllably, as required, heats the pump, the medium in the housing, or both to reverse or prevent freezing of the medium at least in the housing. “Controllably” means that the subject feature is turned on or off and/or operated in an active manner using dedicated component(s), not passively as a result of pump operation. The heat-producing means desirably is “integrated,” by which is meant that components providing or constituting the subject feature are deliberately incorporated into the pump assembly.

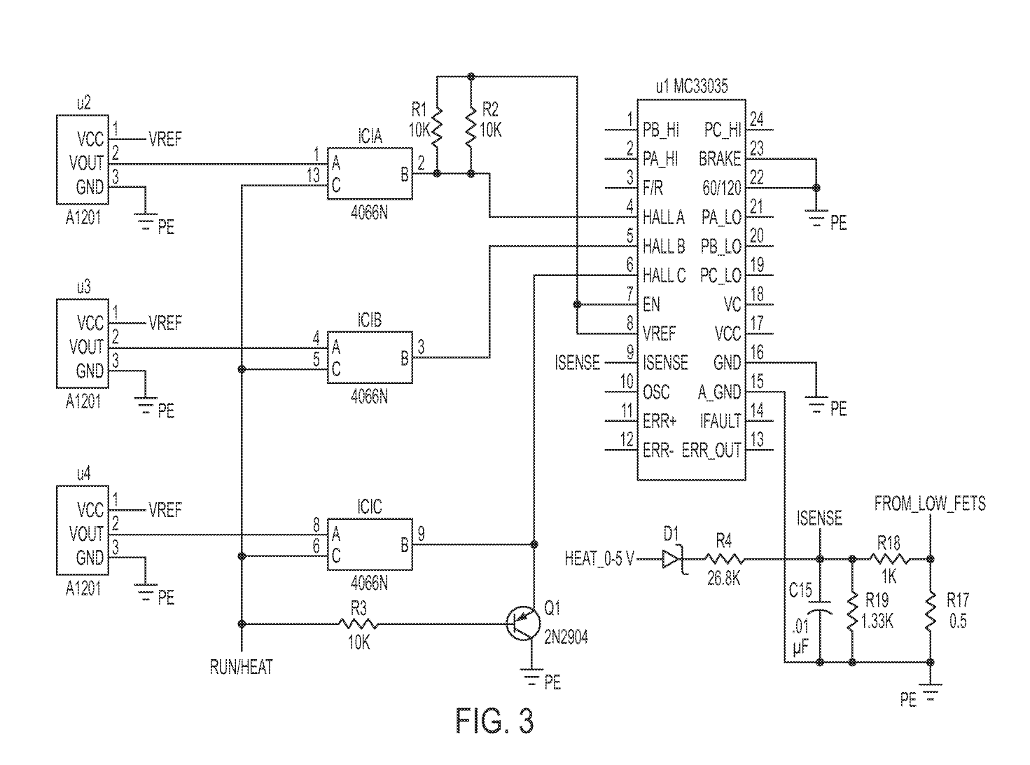

As noted, the stator 34 comprises a core 50 and multiple paired electrical windings 52 (see FIGS. 4A-4B). In certain embodiments it is the stator's own windings 52 and driven magnet 32 that, in conjunction with associated components of the driver circuit 36, fill the role of heating the pump assembly as required. Of course, the stator windings 52 produce and dissipate some heat during normal pump operation, and this heat may be sufficient to prevent freezing in the housing in low ambient temperatures if the pump is continuously operating. But, when the pump is not operating, transfer of heat-producing energy from the stator 34 to the pump can be achieved in several possible ways. The preferred way is by exploitation of the Faraday-Lenz law, which is depicted schematically in FIG. 2, using the stator's own windings. Alternating current (˜) is routed through windings (note I_{I}˜ and I_{K}˜) coiled about a hollow, conductive core C, which produces corresponding induced magnetic lines of force Φ˜. As the alternating current flows through the windings, the resulting eddy currents of alternating magnetic field induce heating of the core C. In an actual pump, the eddy currents of magnetic field produce heating of the core 50 and driven magnet 32. Thus, in these embodiments, the driver circuit 36 operating in cooperation with the existing stator 34 provides a controllable heat source for the pump, including whenever the pump is not in normal pumping operation. Desirably, actuation of pump heating is enabled during times in which the pump is not operating and the ambient temperature is sufficiently low to freeze the medium. Hence, many embodiments include means for detecting an idle pump and means for detecting ambient temperature of the pump. Temperature monitoring can be performed using a temperature sensor 40 (FIG. 1) connected to the control circuit 36. In many embodiments rotation of the driven magnet 32 is detected using Hall sensors 38 or analogous magnetic-field sensors connected to the driver circuit 36. Such detection can be utilized as part of a pump-rate feedback control and regulation performed by the driver circuit 36. The feedback control is determined and executed by a motor-drive chip (a “controller”) in the driver circuit 36 (see FIG. 3, discussed below). The controller includes inputs that receive respective output signals from the Hall sensors 38, which are sensitive to changes in local magnetic field produce by the rotating magnet 32. During normal operation when the pump is actually pumping liquid, the motor-drive chip selectively energizes the stator windings to produce the rotating magnetic field required to rotate the driven magnet 32. Meanwhile, the Hall sensors 38 provide feedback-control data on the rotational velocity of the magnet and on whether the pump is operating at all. In these embodiments, when the pump is turned off, during times in which only heating is required, the motor-drive chip does not energize the stator in a way that produces a rotating magnetic field but nevertheless delivers electrical current to the stator windings for heat production and dissipation into the pump assembly.

An exemplary drive circuit 36 is shown in FIG. 3. In this and many other embodiments, the driver circuit 36 includes automatic switches U2, U3, U4 connected between the Hall sensors 38 and a motor-drive “chip” U1 (see FIG. 3). When the pump is turned off, the switches U2-U4 temporarily disconnect the Hall sensors 38 from providing inputs to the motor-drive chip U1. Meanwhile, the Hall inputs to the motor-drive chip U1 are held in a constant state to prevent the motor-drive chip from interpreting the “disconnected” Hall sensors as corresponding to a pump-error condition. In such a condition, current-limit levels delivered to the stator are manipulated and controlled using an external signal (0 V to 5 V) to control the amount of heat produced by the stator. Stator heat is generated by resistive current-flow losses in the stator windings and output FETs of the driver circuit. In the circuit shown in FIG. 3 and described below, extraneous components have been deleted for the sake of clarity.

Continuing further with FIG. 3, IC1A, IC1B, and IC1C are analog switches. When the RUN/HEAT command is HI, these analog switches allow signals from the Hall sensors to pass through to the motor-drive chip U1, of which an example is an MC33035. The Hall sensors detect and measure rotation of the pump's driven magnet. When the RUN/HEAT command is LO, the Hall sensors become disconnected from this role, while a transistor Q1 is turned on to produce a low pull-down voltage at the emitter of the transistor Q1. Meanwhile, the resistors R1, R2 and the pull-down voltage produced by the transistor Q1 establish valid Hall input states to the drive chip U1. Despite these valid inputs, no change in Hall state is produced as a result of the rotor position being static. The 0-to-5V signal HEAT_{—}0-5 modifies the current-limit signal to the motor-drive chip U1, and hence determines the amount of heat to be produced by the “non-rotating” stator. Since its sense is negative, a 5-V signal will put the motor-drive chip U1 completely into current limit, which stops electrical current from being delivered to the stator and thus inhibits heat generation by the stator. A 0-volt signal puts the motor-drive chip U1 at its maximum current-limited state for producing heat. A diode D1 prevents the 0-volt signal from increasing the specified current limit of the motor-drive chip U1.

By placing at least one thermal sensor 40 at, on, or near the stator, signals from the thermal sensor(s) can be incorporated into a temperature feedback-control loop for the pump assembly. In other words, the thermal sensor(s) is used to monitor pump temperature so as to detect a temperature condition, especially occurring when the pump is idle, indicating a need to heat the pump. The components and values shown in FIG. 3 are appropriate for the MC33035 drive chip with a 2-A design limit, but the principle is applicable to any similar or analogous motor-drive chip.

FIGS. 4A-4B depict an exemplary stator 12 that can be utilized for both driving the pump and heating the pump assembly, as described above. Shown are the core 54 and windings 52. In the pump assembly the rotor housing 28 (not shown) fits into the central void 56. Also shown is a circuit board 58 containing at least a portion of the drive circuit 36 and a connector 60 for providing power and signal input to, and signal output from, the circuitry on the board 58.

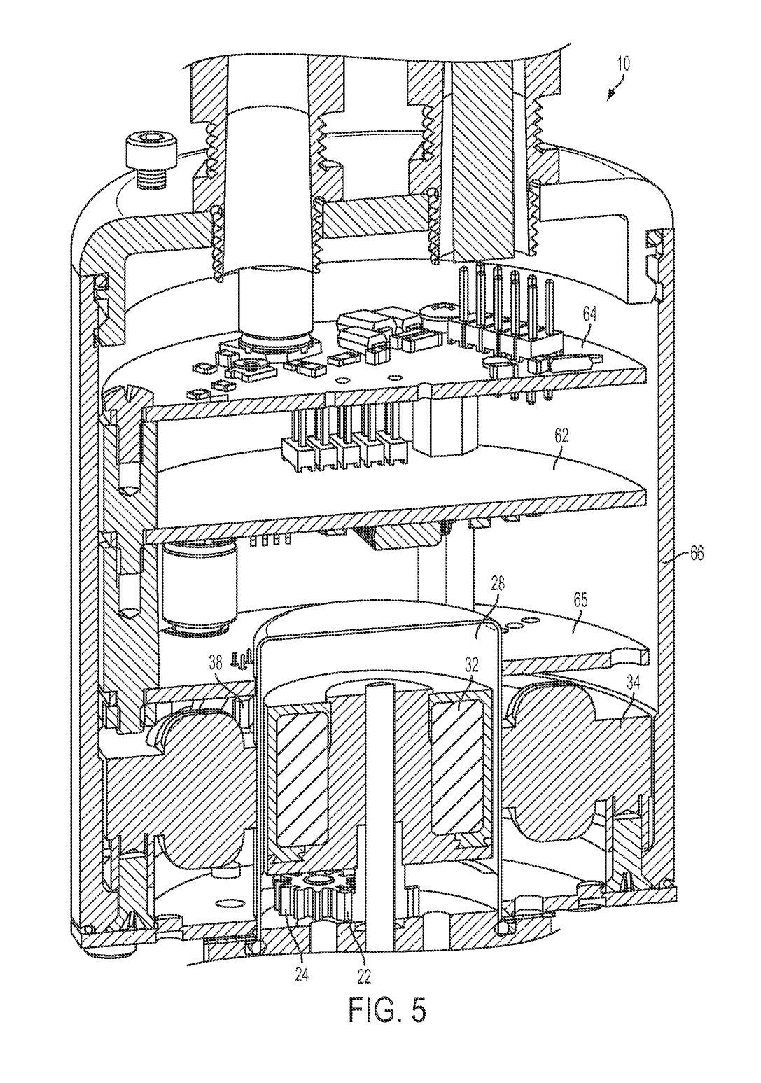

FIG. 5 depicts such a stator 34 mounted in an embodiment of a pump assembly 10. As described above, the stator 34 surrounds the rotor housing 28, in which the rotor 32 is an axially rotatable permanent magnet. The rotor 32 is coupled to pump gears 22, 24 (bottom of figure). Also visible are circuit boards 62, 64 containing motor-control circuitry and motor-drive circuitry, respectively, and one Hall sensor 38 (usually, multiple Hall sensors are used). The motor-control board 62 also includes circuitry (discussed above) that controls heating of the stator 34. The circuit boards 62, 64 and stator 34 in this embodiment are contained in a housing 66 providing protection from the external environment. The housing can be thermally insulated (not shown) if desired to reduce the rate of heat dissipation to outside the housing.

In another embodiment, instead of producing heat using the stator, the controlled electrical currents delivered to the stator windings for heating purposes in the foregoing embodiment are delivered instead to respective resistors that are incorporated into the driver circuit. As electrical current passes through the resistors, they produce and dissipate heat. The closer the resistors to the pump, the greater the efficiency with which the pump can be heated. To such end, the resistor(s) can be located on a circuit board 65 situated as close as possible to the rotor housing 28, for example. It is also possible to heat the pump using both the stator and one or more resistors. Note that the space inside the housing 66 provides a confined space allowing more efficient heat transfer from the resistors (or from the stator, or both) to the pump.

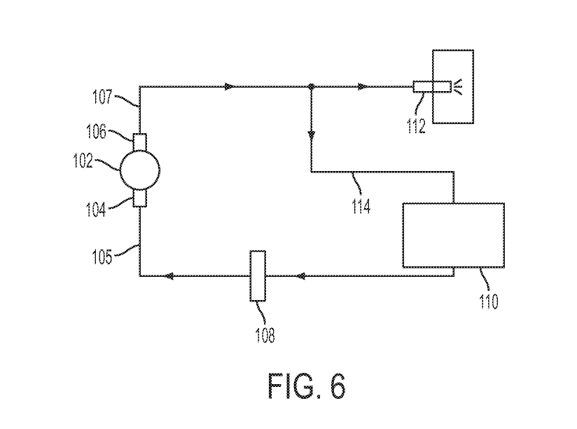

An embodiment directed to another aspect of the invention, namely a hydraulic circuit 100 comprising a pump assembly such as that described above, is shown in FIG. 6. The circuit 100 includes a pump assembly 102 having an inlet 104 and an outlet 106 connected to a first conduit 105 and second conduit 107, respectively. The pump assembly 102 can include a pressure sensor or other type of hydraulically useful sensor (not shown). The inlet 104 is situated downstream of a filter 108, which is situated downstream of a vessel or tank 110 serving as a reservoir for liquid to be pumped by the pump assembly 102. The outlet 106 is hydraulically connected to a downstream injector 112 or other component from which pumped liquid is discharged from the circuit. If desired, the circuit 100 can include a return line 114 for returning liquid to the vessel 110 that is not actually discharged from the injector 112.

Whereas the invention has been described in connection with representative embodiments, it will be understood that it is not limited to those embodiments. On the contrary, it is intended to encompass all alternatives, modifications, and equivalents as may be included within the spirit and scope of the invention as defined by the appended claims.

What is claimed is:

1. A pump assembly, comprising:
a pump housing;
at least one movable pumping element situated in the pump housing;
a driven magnet situated in the pump housing and coupled to the at least one pumping element such that induced movement of the driven magnet causes corresponding motion of the at least one pumping element;
a magnet driver magnetically coupled to the driven magnet, the magnet driver producing a moving magnetic field that induces corresponding motion of the driven magnet and thus of the at least one pumping element;
a heat-producing element; and
a control circuit electrically connected to the magnet driver and heat-producing element, the control circuit comprising a controller configured to provide electrical current selectively to the magnet driver and heat-producing element so as to supply electrical current to the heat-producing element under a temperature condition during which electrical current is not being supplied to the magnet driver.

2. The pump assembly of claim 1, wherein:
the at least one pumping element comprises a driving gear intermeshed with a driven gear; and
the driven magnet is coupled to the driving gear.

3. The pump assembly of claim 1, wherein the magnet driver comprises a stator comprising a core and electrical windings.

4. The pump assembly of claim 3, wherein:
the heat-producing element comprises at least a portion of the core and electrical windings of the stator; and
the control circuit is configured to supply alternating current to the electrical windings to cause the stator to produce heat sufficient to prevent freezing of pump medium in the housing.

5. The pump assembly of claim 4, wherein the stator produces heat by a Faraday-Lenz principle when supplied with the alternating current.

6. The pump assembly of claim 3, wherein:
the heat-producing element comprises at least one electrical resistor; and
the control circuit is configured to provide electrical current to the at least one electrical resistor to cause the resistor to produce the heat.

7. The pump assembly of claim 1, wherein the housing is a sealed housing.

8. The pump assembly of claim 1, wherein the magnet driver, heat-producing element, and control circuit are integral with the pump housing.

9. The pump assembly of claim 1, wherein:
the magnet driver comprises a stator that surrounds a portion of the pump housing; and
the heat-producing element is integral with the stator.

10. The pump assembly of claim 1, further comprising a temperature sensor electrically connected to the control circuit, the control circuit being further configured to receive from the temperature sensor data regarding ambient temperature of the pump assembly and to supply electrical current to the heat-producing element at least whenever the data indicate the potential freezing condition of pump medium in the housing.

11. The pump assembly of claim 10, further comprising a pump-operation sensor electrically connected to the control circuit, the control circuit being further configured to receive from the pump-operation sensor data regarding whether the pump assembly is operating as a pump; and
the control circuit is further configured to supply electrical current to the heat-producing element for a heating purpose if the pump-operation sensor detects the pump assembly is not operating as a pump and the temperature sensor detects a potential freezing condition of the pump medium.

12. The pump assembly of claim 11, wherein the pump-operation sensor comprises at least one sensor of motion of the driven magnet.

13. The pump assembly of claim 12, wherein the sensor of motion comprises at least one Hall sensor situated relative to the driven magnet.

14. The pump assembly of claim 1, wherein:
the control circuit further comprises a pump-operation sensor configured to detect whether the pump assembly is operating as a pump; and
the control circuit is further configured not to supply electrical current to the heat-producing element for a heating purpose if the pump-operation sensor detects actual operation of the pump assembly for pumping a pump medium.

15. The pump assembly of claim 1, wherein:
the magnet driver comprises a stator including a core and associated electrical windings, the windings being selectively energized by the control circuit to cause rotation of the driven magnet for pumping purposes ; and
the heat-producing element comprises at least one electrical winding and associated regions of the core, the at least one electrical winding being selectively energized by the control circuit to produce heat if the windings are not being selectively energized by the control circuit to rotate the driven magnet.

16. A gear-pump assembly, comprising:
a sealed pump housing defining a pump cavity and a cup cavity in hydraulic communication with the pump cavity;
a driving gear and driven gear intermeshed with each other in the pump cavity;
a driven magnet located in the cup cavity and coupled to the driving gear;
a magnet-driver situated outside the pump housing and magnetically coupled to the driven magnet, the magnet-driver producing a moving magnetic field that causes corresponding rotation of the driven magnet, which causes corresponding contra-rotation of the gears in the pump cavity in a manner resulting in a pumped flow of a medium through the pump cavity;
a heating device situated relative to the pump housing to achieve transfer of heat from the heating device to the medium in the housing; and
a heat-control circuit electrically connected to the heating device, the heat-control circuit being electrically energizable in a controlled manner to cause the heating device to generate sufficient heat to prevent freezing of the medium in the housing.

17. The pump assembly of claim 16, wherein the magnet driver is off whenever the heating device is on.

18. The pump assembly of claim 16, further comprising a temperature sensor situated relative to the pump housing and connected to the heat-control circuit to provide temperature data to the heat-control circuit.

19. The pump assembly of claim 18, wherein:
the magnet-driver comprises a stator having multiple electrical windings;
the heating device comprises at least one group of electrical windings of the magnet driver; and
the heat-control circuit is configured to apply respective electrical current to selected electrical windings upon receiving temperature data from the temperature sensor indicating a need to supply heat to the medium in the pump housing.

20. The pump assembly of claim 16, wherein the heat-control circuit is further configured to energize the selected electrical windings during time in which the stator is not producing the moving magnetic field.

21. The pump assembly of claim 16, wherein:
the heating device comprises at least one resistor situated relative to the pump housing; and
the heat-control circuit is configured to apply respective electrical current to the at least one resistor upon receiving temperature data from the temperature sensor indicating a need to supply heat to the medium in the housing, the electrical current being sufficient, when applied across the resistor, to heat the resistor.

22. A hydraulic circuit, comprising:
a first conduit;
a second conduit; and
a pump assembly hydraulically connected between the first conduit and the second conduit to urge flow of a pump medium through the pump assembly from the first to the second conduit, the pump assembly comprising a pump housing, a driven magnet, a magnet driver, a heat-producing element, and a control circuit, the pump housing containing at least one movable pumping element situated in the pump housing, the driven magnet being situated in the pump housing and coupled to the at least one pumping element such that induced movement of the driven magnet causes corresponding motion of the at least one pumping element, the magnet driver being magnetically coupled to the driven magnet and producing a moving magnetic field that induces corresponding motion of the driven magnet and thus of the at least one pumping element, and the control circuit being electrically connected to the magnet driver and heat-producing element, the control circuit comprising a controller configured to provide electrical current selectively to the magnet driver and heat-producing element so as to supply electrical current to the heat-producing element under a potential freezing condition when electrical current is not being supplied to the magnet driver.

23. A hydraulic circuit, comprising:
a first conduit;
a second conduit; and
a gear-pump assembly hydraulically connected between the first conduit and the second conduit, the gear-pump assembly comprising a sealed pump housing, a magnet-driver, a heating device, and a heat-control circuit, the sealed pump housing defining a pump cavity and a cup cavity in hydraulic communication with the pump cavity, wherein a driving gear and driven gear are intermeshed with each other in the pump cavity and a driven magnet is located in the cup cavity and coupled to the driving gear, the magnet-driver being situated outside the pump housing and magnetically coupled to the driven magnet, the magnet-driver producing a moving magnetic field that causes corresponding rotation of the driven magnet, which causes corresponding contra-rotation of the gears in the pump cavity in a manner resulting in a pumped flow of a medium through the pump cavity, the heating device being situated relative to the pump housing to achieve heat transfer from the heating device to the medium in the housing, and the heat-control circuit being electrically connected to the heating device and being electrically energizable in a controlled manner to cause the heating device to generate sufficient heat to prevent freezing of the medium in the housing.

24. A pump assembly, comprising:
a sealed pump housing;
a movable pumping element situated in the housing;
a magnetically responsive device located in the housing and coupled to the pumping element;
magnet-driving means for magnetically engaging the magnetically responsive means with a moving magnetic field and for inducing, with said moving magnetic field, corresponding motion of the magnetically responsive means and thus of the pumping element;
control means for electrically actuating said magnetic-driving means to induce pumping motion of the pumping element in the housing;
temperature-sensing means for monitoring temperature of the pump assembly and providing temperature data to the control means;
pump-operation means for monitoring whether pump assembly y is operating as a pump and providing operation data to the control means;
pump-heating means controlled by said control means, for heating at least a portion of the pump housing to reverse or prevent freezing of a pump medium in the pump housing, including during a time when the temperature data indicate at least a potential for freezing and the operation data indicate the pump assembly is not operating

25. The assembly of clam 24, wherein the magnet-driving means and pump-heating means are integral.
